(19) United States
(12) Patent Application Publication
(10) Pub. No.: US 2008/0199021 A1
(43) Pub. Date: Aug. 21, 2008

(54) Method and Apparatus For Providing Ip Datacasting Service in Digital Audio Broadcasting System

(75) Inventor: Jeong-Hoon Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/995,638

(22) PCT Filed: Jul. 12, 2006
(86) PCT No.: PCT/KR2006/002731

§ 371 Date: Jan. 14, 2008

(30) Foreign Application Priority Data
Jul. 12, 2005 (KR) 10-2005-0062884

(51) Int. Cl. H04B 3/00

(52) U.S. Cl. 381/81

(57) ABSTRACT

Provided are a method and apparatus for providing an IP datacasting service in a digital broadcasting system. The method for providing the IP datacasting service in the digital broadcasting system includes: generating service configuration information indicating that the IP datacasting service is provided; packetizing data to be transmitted and generating IP packet data; formatting information related to a configuration of the IP packet data by using a predetermined protocol; and transmitting the service configuration information, the IP packet data, and the information related to the configuration of the IP packet data through separate channels, respectively. Accordingly, various information related to transmitted multimedia data is transmitted together with the multimedia data, so that an IP datacasting function for appropriately processing the multimedia data according to the type of the multimedia data is provided.

### CROSS-REFERENCE TO RELATED PATENT APPLICATION

This application claims the benefit of Korean Patent Application No. 10-2005-0062884, filed on Jul. 12, 2005, in the Korean Intellectual Property Office, the disclosure of which is incorporated herein in its entirety by reference.

### BACKGROUND OF THE INVENTION

1. Field of the Invention

The present invention relates to a digital audio broadcasting (DAB) system, and more particularly, to a method and apparatus for providing an IP datacasting service in a DAB system.

2. Description of the Related Art

Digital audio broadcasting (DAB) is a broadcast system developed to digitize existing AM and FM radio broadcasts in Europe. DAB provides audio and data services and is also called “EUREKA 147 DAB”.

FIG. 1 illustrates a structure of a DAB frame 800 in a DAB system.

Referring to FIG. 1, the DAB frame 800 includes a synchronization channel 802, a fast information channel (FIC) 804, and a main service channel (MSC) 806.

The synchronization channel 802 includes information for synchronization used when the DAB frame 800 is demodulated. The FIC 804 includes a variety of control information, urgent data requiring fast transmission, and service information. Signals transmitted through an FIC can be quickly transmitted, as they do not pass through a time interleaver, which is different from signals transmitted through an MSC. However, the size of the signals transmitted through the FIC is limited to 32 bytes.

Meanwhile, the MSC 806 includes data for a plurality of audio services and a plurality of data services. As illustrated in FIG. 1, one DAB frame 800 includes a plurality of service channels 808, and each service channel 808 includes a plurality of subchannels 810. The respective subchannels are independently encoded and interleaved and thus multiplexed to the MSC 806.

Meanwhile, in the DAB system, a data service is classified into a stream mode and a packet mode. In particular, in order to transmit IP packets in packet mode, IP tunneling is used. The IP tunneling is described in detail in the ETSI TS 101 735 v1.1.1.

FIG. 2 is a view for explaining an IP tunneling service in the DAB system.

Referring to FIG. 2, the IP tunneling service processes IP packets as information to be transmitted, without considering inside information regarding the IP packets. In the case when multimedia data is transmitted using IP tunneling in a conventional DAB system, a DAB transmitter 900 or a DAB receiver 902 cannot recognize what content is included in an IP packet corresponding to the multimedia data, that is, whether the IP packet is a file, a video stream, or an audio stream. Accordingly, the DAB transmitter 900 or DAB receiver 902 is used only as a passage through which IP packets are transmitted, and cannot adaptively process transmitted multimedia data.

### SUMMARY OF THE INVENTION

The present invention provides a method and apparatus for providing an IP datacasting service in a digital audio broadcasting (DAB) system, in a manner that allows a DAB receiver and a DAB transmitter to identify information regarding an IP packet when multimedia data is transmitted using the IP packet.

According to an aspect of the present invention, there is provided a method of providing an IP datacasting service in a digital broadcasting system, including: generating service configuration information indicating that the IP datacasting service is provided; packetizing data to be transmitted and generating IP packet data; formatting information related to a configuration of the IP packet data by using a predetermined protocol; and transmitting the service configuration information, the IP packet data, and the information related to the configuration of the IP packet data through separate channels, respectively.

The service configuration information is transmitted through a fast information channel, and the IP packet data is transmitted using a data service of a main service channel (MSC).

Information related to the configuration of the IP packet data is formatted in a session description protocol (SDP) format, the information related to the configuration of the IP packet data formatted in the SDP format is transmitted using a Multimedia Object Transfer (MOT) method among data services of a main service channel (MSC), the information related to the configuration of the IP packet data formatted in the SDP format is transmitted using an IP packet method among data services of a main service channel (MSC), and the information related to the configuration of the IP packet data formatted in the SDP format is transmitted through a fast information channel (FIC).

According to another aspect of the present invention, there is provided a method of providing an IP datacasting service in a digital broadcasting system, including: receiving a digital broadcast signal; demultiplexing the received digital broadcast signal for each channel; extracting service configuration information indicating that the IP datacasting service is provided, from a fast information channel (FIC); extracting information related to a configuration of IP packet data formatted by using a predetermined protocol, from a main service channel (MSC); extracting packetized transmission data from the MSC; and processing the IP packet data using the extracted service configuration information and the extracted information related to the configuration of the IP packet data, wherein the service configuration information, the information related to the configuration of the IP packet data, and the IP packet data are received through separate channels, respectively.

According to another aspect of the present invention, there is provided an transmitting apparatus for providing an IP datacasting service in a digital broadcasting system, including: an IP packetization unit packetizing data to be transmitted and generating IP packet data; a SDP formatting unit formatting information related to a configuration of the IP packet data by using a predetermined protocol; and a controller generating service configuration information indicating that the IP datacasting service is provided, and transmitting the service configuration information, the IP packet data, and the information related to the configuration of the IP packet data, through separate channels, respectively.

According to another aspect of the present invention, there is provided a receiving apparatus for providing an IP datacasting service in a digital broadcasting system, comprising: a demultiplexer demultiplexing a received digital broadcast signal for each channel; a controller extracting service configuration information indicating that the IP datacasting service is provided, from a fast information channel (FIC), and extracting information related to a configuration of IP packet data formatted with a predetermined protocol and packetized transmission data, from a main service channel (MSC); and an IP packet processor processing the IP packet data using the extracted service configuration information and the information related to the configuration of the IP packet data, wherein the service configuration information, the information related to the configuration of the IP packet data, and the IP packet data are received through separate channels, respectively.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a digital audio broadcasting (DAB) frame in a DAB system;

FIG. 2 is a view for explaining an IP tunneling service in a DAB system;

FIG. 3 is a block diagram of a DAB system for providing an IP datacasting service, according to an embodiment of the present invention;

FIG. 4 is a block diagram of an IP datacasting processor illustrated in FIG. 3;

FIG. 5 is a block diagram of a DAB transmitting apparatus for providing an IP datacasting service, according to an embodiment of the present invention;

FIGS. 6A and 6B are views for explaining IP packet data for an IP datacasting service, according to an embodiment of the present invention;

FIG. 7 is a view illustrating IP packet configuration information for an IP datacasting service, according to an embodiment of the present invention;

FIGS. 8A, 8B, and 8C are views for explaining various data transmission methods of providing an IP datacasting service, according to embodiments of the present invention;

FIGS. 9A and 9B are views for explaining a fast information channel (FIC) signaling method of transmitting service configuration information of an IP datacasting service;

FIG. 10 is a view for explaining a transmission method using a Multimedia Object Transfer (MOT) illustrated in FIG. 8A, according to a first embodiment of the present invention;

FIG. 11 illustrates a structure of an MOT packet;

FIG. 12 is a view for explaining a transmission method using an IP packet illustrated in FIG. 8B, according to a second embodiment of the present invention;

FIG. 13 is a view for explaining a transmission method using an FIC illustrated in FIG. 8C, according to a third embodiment of the present invention;

FIG. 14 is a view for explaining an operation of a DAB receiver for providing an IP datacasting service, according to an embodiment of the present invention; and

FIGS. 15 through 19 are views for explaining various embodiments to which the IP datacasting service according to the present invention is applied.

### DETAILED DESCRIPTION OF THE INVENTION

Hereinafter, embodiments of the present invention will be described in detail with reference to the appended drawings. In this specification, if it is determined that detailed descriptions related to functions or constructions well-known in the art make the concept of the present invention obscure unnecessarily, the detailed descriptions will be omitted. Also, the following terms are defined considering the function of the present invention and can vary according to intensions of users or operators or usual practices. Therefore, such terms must be defined on the basis of the entire contents of the specification.

The present invention proposes a method and apparatus for providing an IP datacasting service, in a manner that allows a DAB transmitter and a DAB receiver to identify information regarding an IP packet when multimedia data is transmitted using the IP packet, in a DAB system.

IP datacasting means broadcasting multimedia data, such as files, still pictures, moving-picture streams, etc., to a plurality of users. In conventional IP tunneling, a DAB receiver and a DAB transmitter can not identify the content of IP packets received or transmitted. However, in the IP datacasting service according to an embodiment of the present invention, a DAB receiver and a DAB transmitter can identify the content of IP packets received or transmitted.

Hereinafter, an example in which IP datacasting of a moving-picture stream which is multimedia data, will be described. However, the invention is not limited to moving-picture streams, and can be applied to different multimedia data.

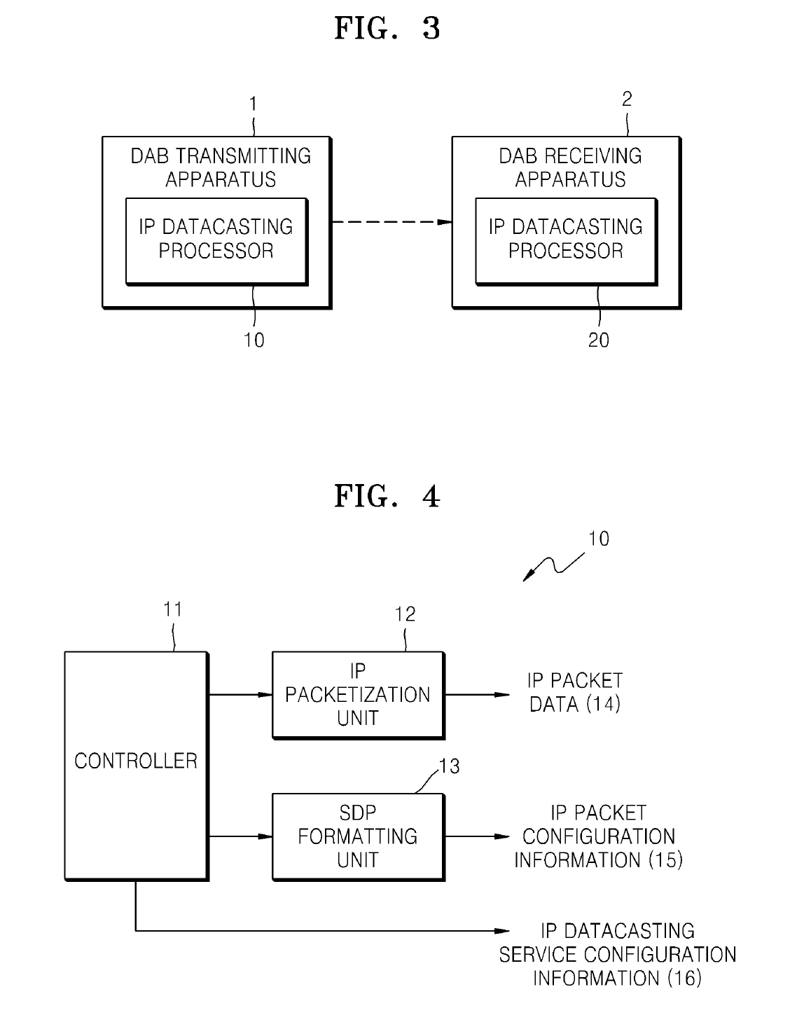

FIG. 3 is a block diagram of a DAB system for providing an IP datacasting service, according to an embodiment of the present invention.

Referring to FIG. 3, a DAB transmitting apparatus 1 and a DAB receiving apparatus 2, according to the present invention, include IP datacasting processors 10 and 20, respectively, as well as general components for encoding, interleaving, and multiplexing a service channel. The IP datacasting processors 10 and 20 packetizes multimedia data to be transmitted into IP packets, and additionally generate information regarding the IP packets and information regarding the IP datacasting service.

FIG. 4 is a block diagram showing a structure of the IP datacasting processor 10 illustrated in FIG. 3.

Referring to FIG. 4, the IP datacasting processors 10 and 20 include a controller 11, an IP packetization unit 12, and a session description protocol (SDP) formatting unit 13.

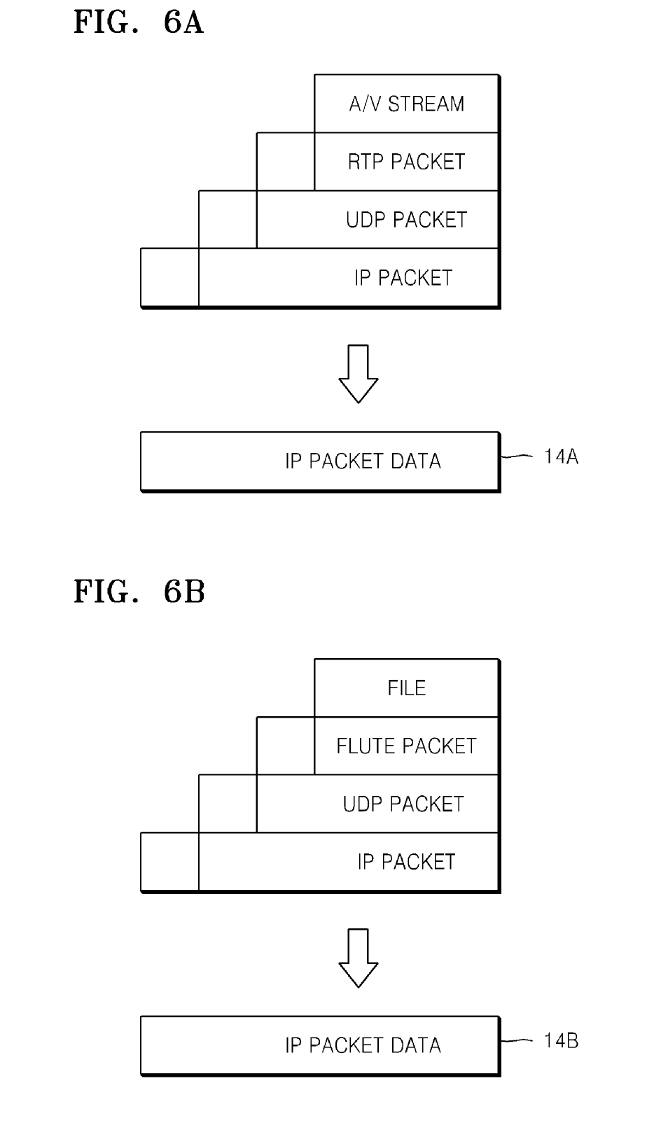

The IP packetization unit 12 packetizes multimedia data to be transmitted into an IP packet. In more detail, FIGS. 6A and 6B are views for explaining IP packet data for an IP datacasting service, according to an embodiment of the present invention. Referring to FIG. 6A, a moving-picture stream (that is, an audio/video (AN) stream) is compression-encoded, packetized by a real-time transport protocol (RTP) method, and then packetized by a user datagram protocol (UDP) method. The resultant RTP/UDP packet is packetized by an IP method and becomes RTP/UDP/IP packet data 14A. The RTP/UDP/IP packet data 14A will be simply referred to as IP packet data 14 below. Also, referring to FIG. 6B, a file is packetized by File Delivery Over Unidirectional Transport (FLUTE) method and then packetized by the UDP method. Then, the resultant FLUTE/UDP packet is packetized by an IP method and thus becomes FLUTE/UDP/IP packet data 14B. Likewise, the FLUTE/UDP/IP packet data 14B will be simply referred to as IP packet data 14 below. As described above, returning to FIG. 4, the IP packet data 14 includes multimedia data to be transmitted.

Meanwhile, the SDP formatting unit 13 formats information used for IP packeting in the form of SDP information. A method for formatting the information may be RFC2327 which is a SDP specification.

That is, when multimedia data, such as moving-picture streams or files, is packetized into IP packet data by the IP packetization unit 12, various information related to packetization of the IP packet data, that is, IP packet configuration information, is formatted in the SDP format.

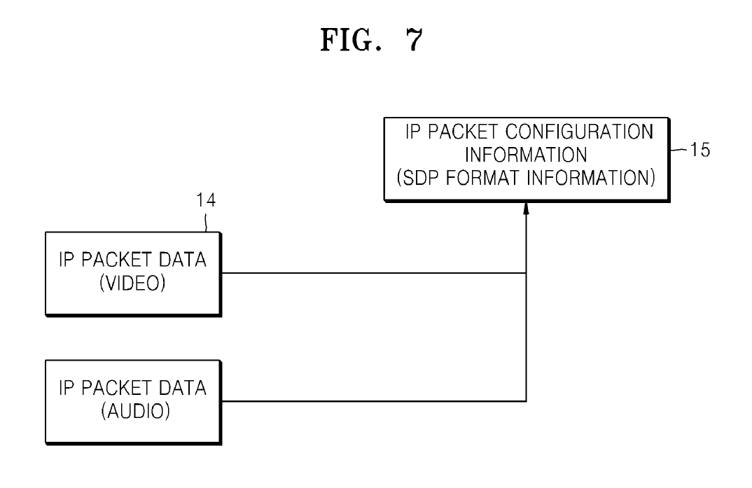

In more detail, FIG. 7 is a view illustrating IP packet configuration information 15 for an IP datacasting service, according to an embodiment of the present invention.

Referring to FIG. 7, information required for IP-packetizing multimedia data, such as video or audio, files, etc., is the IP packet configuration information 15. The IP packet configuration information 15 can be also referred to as SDP format information. For example, in the case of an RTP packet, when a video stream or an audio stream is packetized into IP packets, information for a packetization method applied to the RTP packet, information indicating whether the RTP packet is an audio stream or a video stream, a port number of a UDP packet, version information of an IP packet, etc. are included in the IP packet configuration information 15. Returning to FIG. 4, by performing the above-described operations, the IP datacasting processor 10 outputs the IP packet data 14 and the IP packet configuration information 15 having a SDP format. The IP packet data 14 and the IP packet configuration information 15 having the SDP format are transmitted using a data service of a main service channel (MSC) of the DAB transmitting apparatus 1 (see FIG. 3).

When SDP format information, that is, IP packet configuration information, is transmitted as general text information through a Multimedia Object Transfer (MOT) packet, an exemplary SDP configuration is as follows.

m=video 49170 RTP/AVP 98

a=rtpmap:98 H264/90000

Here, the SDP format information indicates that the corresponding multimedia is a video stream, is transmitted through a UDP port 49170, and encoded according to the H.264 standard using a 98-th payload type of a RTP packet. Also, the SDP format information indicates that a time stamp of the RTP packet is configured with time information of 90 kHz.

As another embodiment, an example in which SDP format information is configured and transmitted in a format of XML is as follows.

```
<def>
  <audio:codec name=“MPEG-4 HE-AAC” encoding=“HE_AAC
                channels=“2” sampling=“44100”/>
  <rtp:pt name=“rtp-avp-18” pt=“18” format=“HE_AAC”/>
</def>
```

Here, the SDP format information indicates that the corresponding multimedia data is an RTP packet encoded according to the MPEG-4 HE-AAC standard and having an 18-th RTP payload type. Such SDP format information 15 is input to a data encoder (which will be described later) in the DAB transmitting apparatus 1. The data encoder is divided to a MOT encoder and a packet mode encoder according to a transmission method.

Meanwhile, referring to FIG. 4, the controller 11 outputs service configuration information 16 for the IP datacasting service. The service configuration information 16 is transmitted through a fast information channel (FIC) by the DAB transmitting apparatus 1. The IP datacasting service may be notified that the corresponding data service uses an IP packet, using a Data Service Component type (DSCTy) field which is a data service component type of ETSI EN 300 401. Also, the IP datacasting service may notify that the corresponding data service is an IP datacasting application, using a UAtype field which is a user application type

Hereinafter, the entire structure and operation of the DAB transmitting apparatus 1 for providing an IP datacasting service, according to an embodiment of the present invention, will be described in detail.

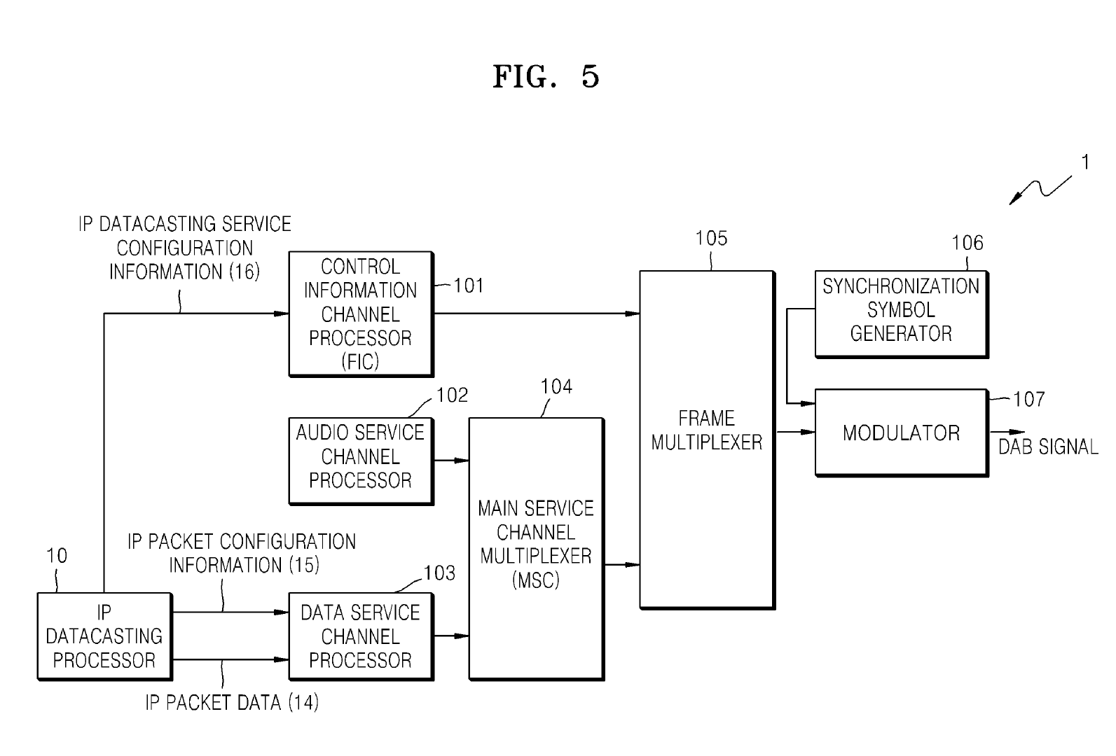

FIG. 5 is a block diagram of a DAB transmitting apparatus 1 for providing an IP datacasting service, according to an embodiment of the present invention.

Referring to FIG. 5, the DAB transmitting apparatus 1 includes an IP datacasting processor 10, a data service channel processor 103, an audio service channel processor 102, a control information channel processor 101, a main service channel multiplexer 104, a frame multiplexer 105, a synchronization symbol generator 106, and a modulator 107.

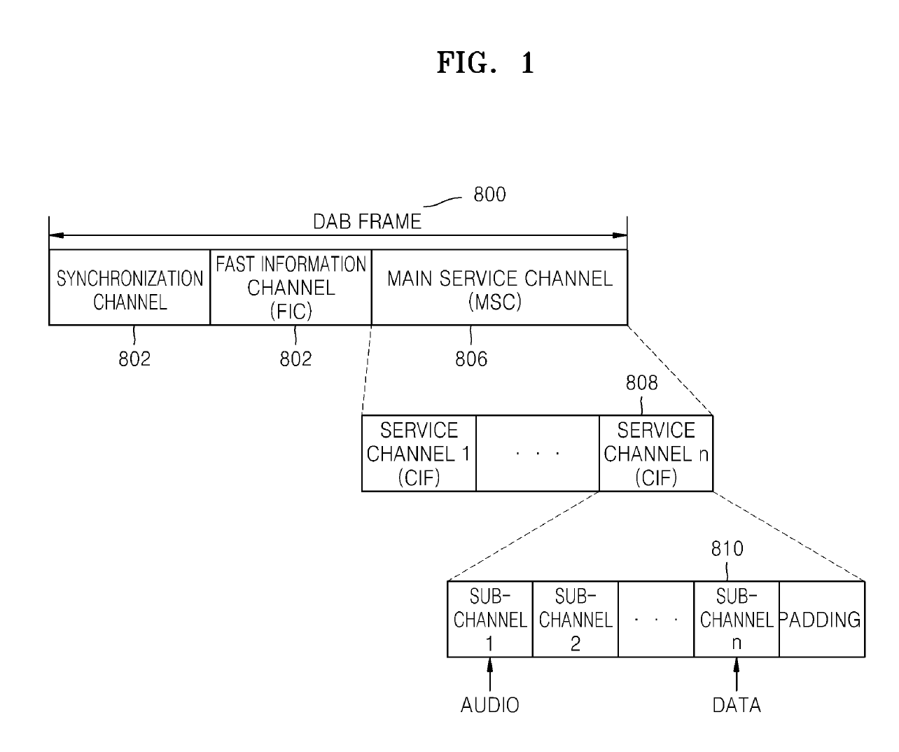

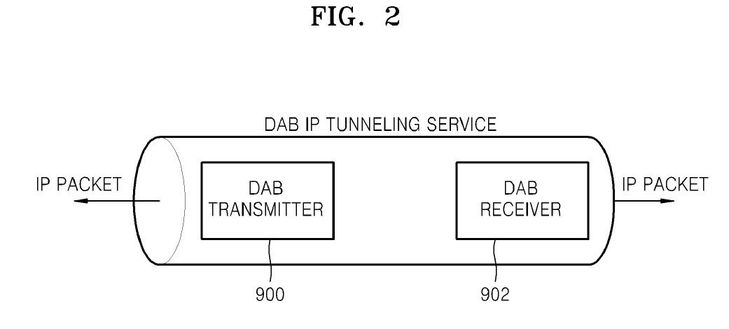

The IP datacasting processor 10 outputs IP datacasting service configuration information 16, IP packet configuration information 15, and IP packet data 14, in order to provide an IP datacasting service. The internal structure of the IP datacasting processor 10 is described above with reference to FIG. 4. The data service channel processor 103 processes a data service signal in a DAB system, and an audio service channel processor 102 processes an audio service signal. The control information channel processor 101 processes control information and service information for multiplexing the respective services, and FIC data requiring urgent transmission. A signal of a data service channel and a signal of an audio service channel are multiplexed by the main service channel multiplexer 104. The multiplexed signal is multiplexed together with a signal of a control information channel by the frame multiplexer 105. The resultant signal is modulated together with synchronization information from the synchronization symbol generator 106 by the modulator 107, and is output as a DAB frame. The DAB frame, as described above with reference to FIG. 1, includes a synchronization channel, a FIC, and an MSC.

As described above, the audio service signal and data service signal to be transmitted are multiplexed to form a DAB signal. Multiplexing of the DAB signal will now be described in detail below.

First, multiplexing of the audio service signal is described. The audio service channel processor 102 compression-encodes input audio data in order to enhance transmission efficiency. The compression-encoding is based on the MPEG 1 Audio Layer-2 specification or on the MPEG 2 Audio Layer-2 specification. Also, the audio service channel processor 102 performs energy distribution scrambling in order to remove a specific pattern repeatedly appearing in the compression-encoded data, thereby converting the compression-encoded data into a random pattern. Furthermore, the audio service channel processor 102 performs convolution encoding and puncturing for channel encoding. A variety of puncturing vectors can be used for the puncturing, and an encoding rate depends on the puncturing vectors used. A decision on which encoding rate is applied from among selectable encoding rates is performed according to the type and characteristics of data to be currently transmitted, by the DAB transmitting apparatus 1. The DAB transmitting apparatus 1 selects an encoding rate from among selectable encoding rates, considering whether data to be currently transmitted is sensitive to error characteristics or to delay characteristics. If the data is sensitive to error characteristics, the DAB transmitting apparatus 1 selects an encoding rate at which error correction capability can be enhanced. If the data is sensitive to delay characteristics, the DAB transmitter selects an encoding rate at which a data transmission rate can be enhanced. Here, since information for the encoding rate selected by the DAB transmitting apparatus 1 must be transmitted to the DAB receiving apparatus 2, the information about the selected encoding rate is included as multiplexing configuration information in a FIC.

Then, time interleaving is performed on the channel-encoded data. By varying the output order of input signals according to a predetermined rule, the order of the interleaved output data varies. Thus, although burst errors are generated when the data is transmitted, by allowing the DAB receiving apparatus 2 (see FIG. 3) to perform inverse-interleaving, the positions of bits in which errors are generated are scattered, which generates random errors and allows error correction in a decoder. The data subjected to time interleaving is input to the main service channel multiplexer 104. In the case of audio services, one or more services can be simultaneously provided. The above-described audio service channel processing is independently performed on respective services, and then the processed services are input to the main service channel multiplexer 104.

Meanwhile, the data service channel processor 103 also performs the above-described encoding, energy distribution scrambling, channel encoding, and time interleaving on the received data, and then transfers the resultant data to the main service channel multiplexer 104. The data is multiplexed together with the audio signal into a main service channel (MSC) signal. As described above, a signal for an audio service and a signal for a data service are independently subjected to encoding, energy distribution scrambling, channel encoding, and time interleaving, and then input to the main service channel multiplexer 104. Independently performing signal processing for each service means that each service can have a different encoding rate. A unit in which encoding is independently performed for each service is called a “sub channel” which is a physical concept.

Sub channel data multiplexed by the main service channel multiplexer 104 constitutes a main service channel (MSC). The MSC is multiplexed together with the FIC into a signal by the frame multiplexer 105, and a synchronization channel is added to the resultant signal, thereby generating a DAB frame. The DAB frame is also called an “Ensemble”.

Meanwhile, the control information channel processor 101 multiplexes control information consisting of a FIC data service signal, multiplexing configuration information, service information, etc., and performs energy distribution scrambling and channel encoding on the multiplexed results, thus configuring an FIC. Since the FIC is temporally prior to the MSC in the frame structure as illustrated in FIG. 1, and also not subjected to time interleaving, the DAB receiving apparatus 2 can demodulate the FIC faster than the MSC.

The signal passing through the frame multiplexer 105 is transferred to the modulator 107. The modulator 107 performs data modulation, frequency interleaving, and Orthogonal Frequency-Domain Multiplexing (OFDM) modulation on the signal. Then, a synchronization channel is added to the resultant signal by the synchronization symbol generator 106, so that the DAB frame is generated. At this time, a TII signal, which is transmitter identification information, is added to the DAB signal.

In this manner, a DAB frame for providing an IP datacasting service is generated. Hereinafter, a method for transmitting the DAB frame will be described. Particularly, in order to provide the IP datacasting service according to the present invention, a method for transmitting the IP packet data 14, the IP packet configuration information 15, and the IP datacasting service configuration information 16 will now be described below.

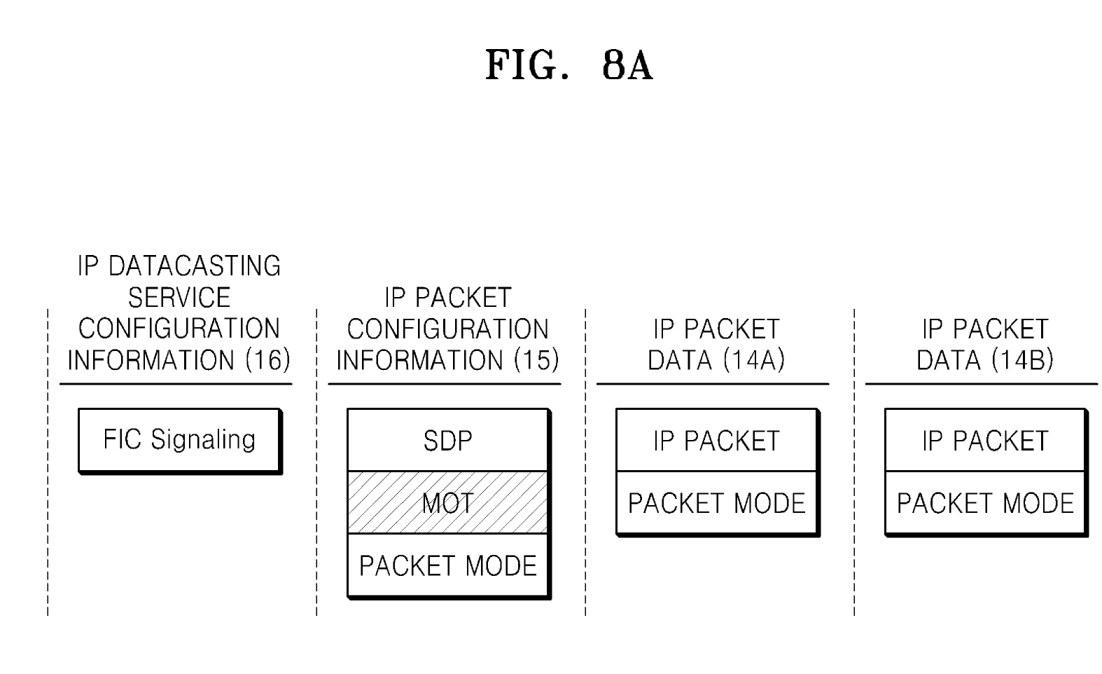

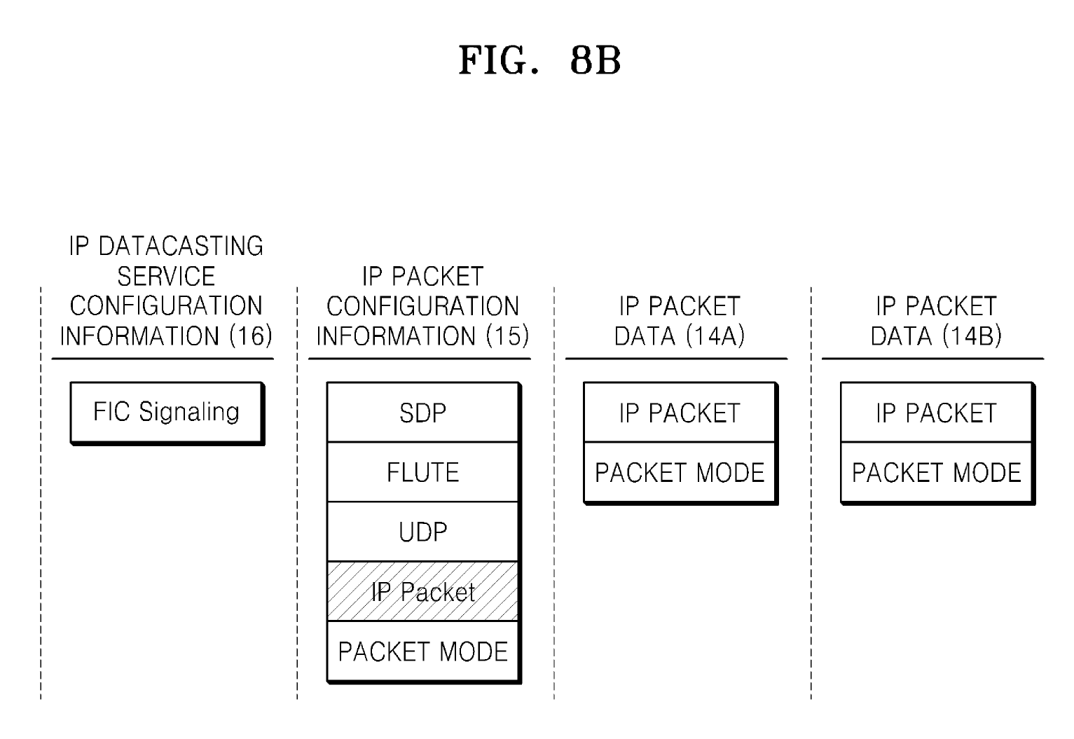

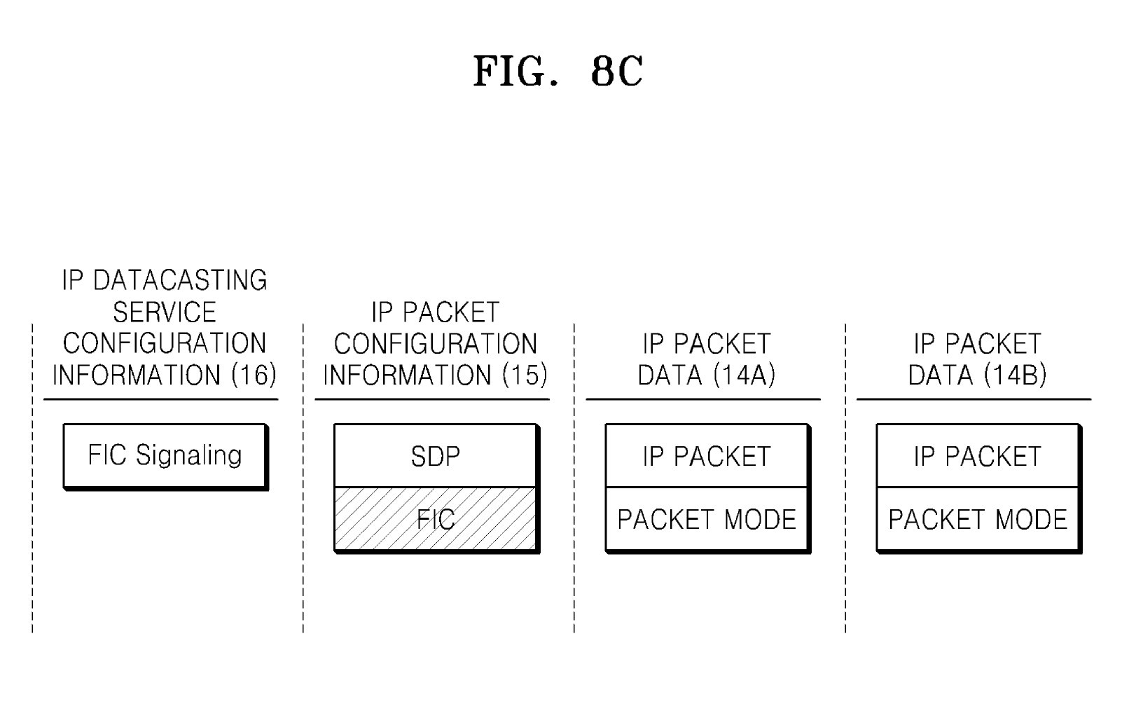

FIGS. 8A, 8B, and 8C are views for explaining various data transmission methods of providing an IP datacasting service, according to first, second, and third embodiments of the present invention.

FIG. 8A illustrates a first embodiment in which IP packet configuration information 15 is transmitted through a MOT method, FIG. 8B illustrates a second embodiment in which IP packet configuration information 15 is transmitted through an IP packet method, and FIG. 8C illustrates a third embodiment in which IP packet configuration information 15 is transmitted through an FIC.

Here, IP datacasting service configuration information 16 and IP packet data 14 are transmitted in the same manner in the first, second, and third embodiments. That is, in all of the first, second, and third embodiments, the IP datacasting service configuration information 16 is transmitted by FIC signaling and the IP packet data 14 is transmitted through the IP packet method. Hereinafter, data transmission methods according to the first, second, and third embodiments will be respectively described in detail.

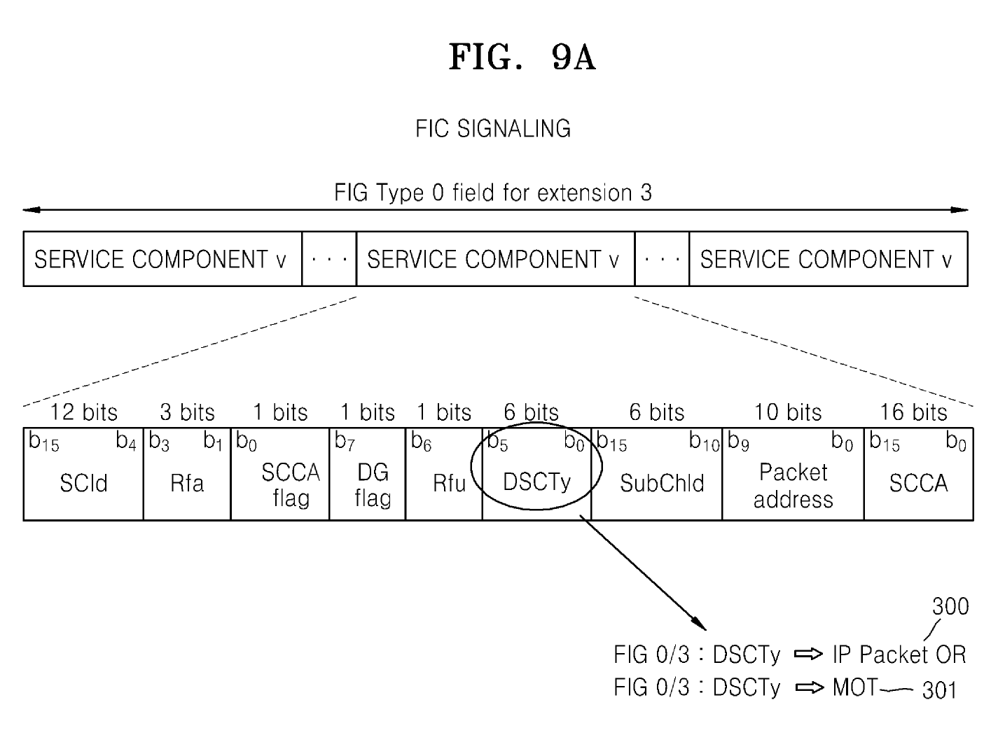

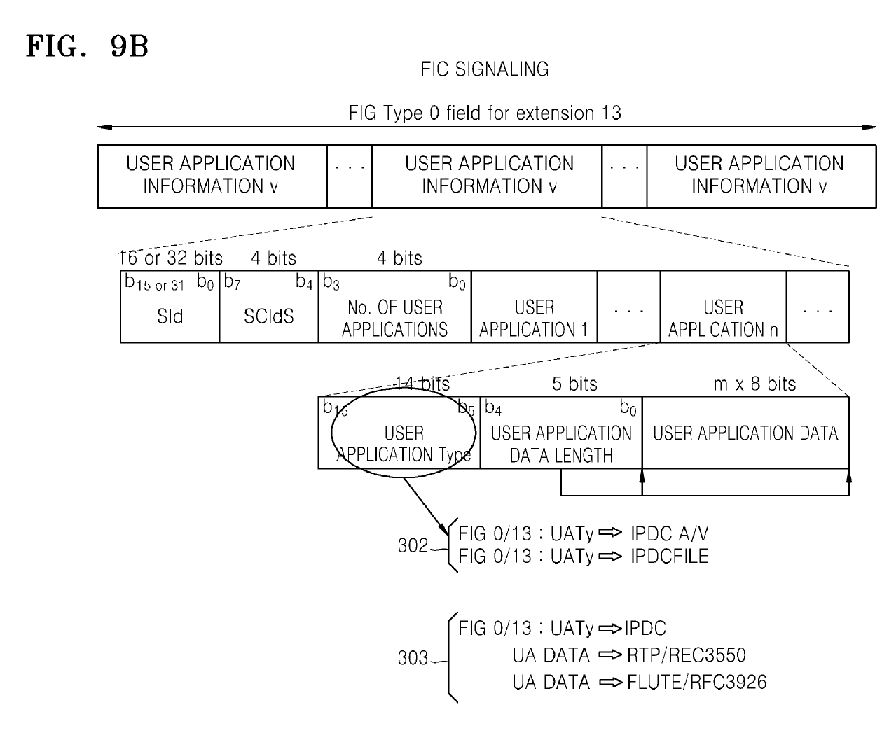

FIGS. 9A and 9B are views for explaining an FIC signaling method of transmitting service configuration information of an IP datacasting service.

A fast information channel (FIC) consists of a plurality of fast information blocks (FIBs), and each FIB consists of a plurality of fast information groups (FIGs).

FIG. 9A illustrates a structure of service components of a fast information group (FIG. 0/3). As illustrated in FIG. 9A, a method in which SDP format information which is IP packet configuration information is transmitted, can be designated using a DSCTy field. When SDP format information is transmitted by the IP packet method, the DSCTy field can designate an IP packet 300. Also, when the SDP format information is transmitted by the MOT method, the DSCTy field can designate a MOT 301.

Meanwhile, FIG. 9B illustrates a structure of user application information of a fast information group (FIG. 0/13). Whether the corresponding service allows moving-picture streams to be subjected to IP datacasting (IPDC) or files to be applied to IP datacasting can be designated using a UAType field of the FIG. 0/13.

Meanwhile, instead of designating information for the IP datacasting service using FIG. 0/3 and FIG. 0/13, the information for the IP datacasting service can be designated using only the FIG. 0/13 (303). For example, the UAType field of the FIG. 0/13 can designate an IP datacasting service, and a UA Data field of the FIG. 0/13 can designate a transmission protocol. The above-described embodiments are several proposals for FIG signaling, but are not limited thereto and various modifications are possible.

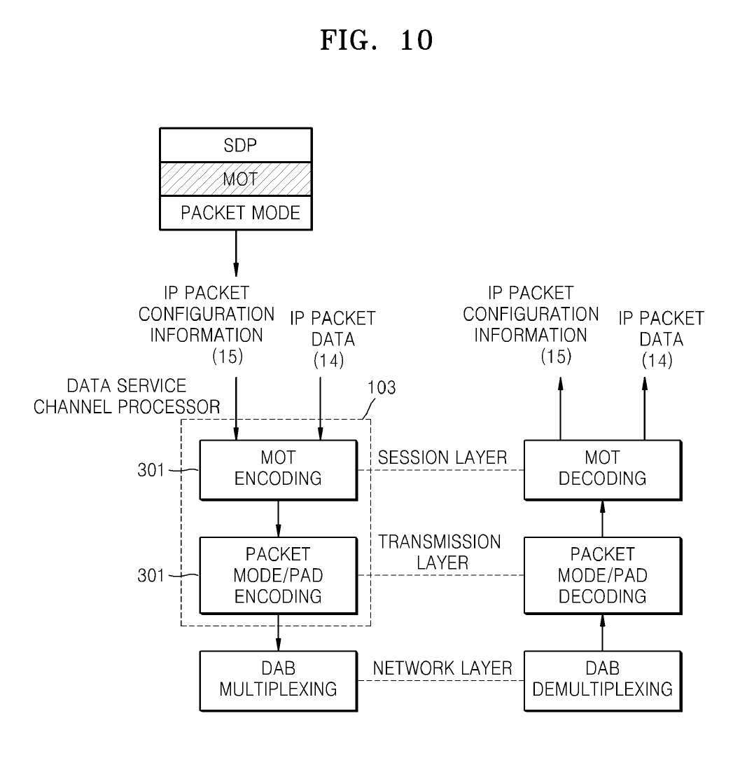

FIG. 10 is a view for explaining a transmission method using MOT illustrated in FIG. 8A, according to a first embodiment of the present invention.

FIG. 10 illustrates a case in which SDP format information which is IP packet configuration information 15 is transmitted by an MOT method. A data service channel processor 103 of a DAB transmitting apparatus 1 (see FIG. 3) performs MOT-encoding on the IP packet configuration information 15 according to the DAB standard, and then performs packet MOT/PAD encoding on the MOT-encoded information. The encoded signal is multiplexed into a DAB signal.

Meanwhile, a DAB receiving apparatus 2 (see FIG. 3) receives and demultiplexes the DAB signal and performs packet MOT/PAD decoding and MOT decoding on the demultiplexed DAB signal, thereby interpreting IP packet configuration information.

In more detail, FIG. 11 illustrates a structure of an MOT packet.

Referring to FIG. 11, an MOT encoder inputs required information to a header core of the MOT packet so that the DAB receiving apparatus 2 can interpret IP packet configuration information which is SDP format information 15. Since the SDP format information can be generally configured as text-based information, a ContentType field 3012 can be set to 0×000001 which indicates text and a ContentType field 3013 can be set to 0×000000011 which indicates SDP format information. However, the invention is not limited to these.

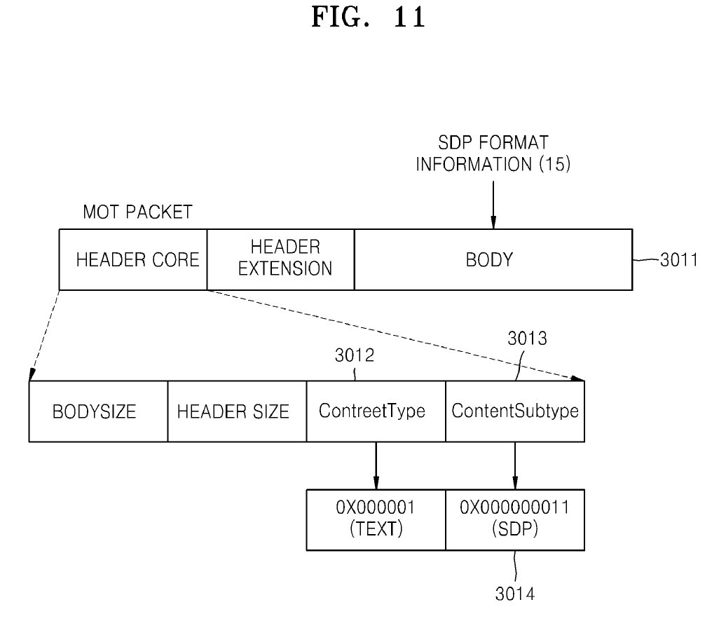

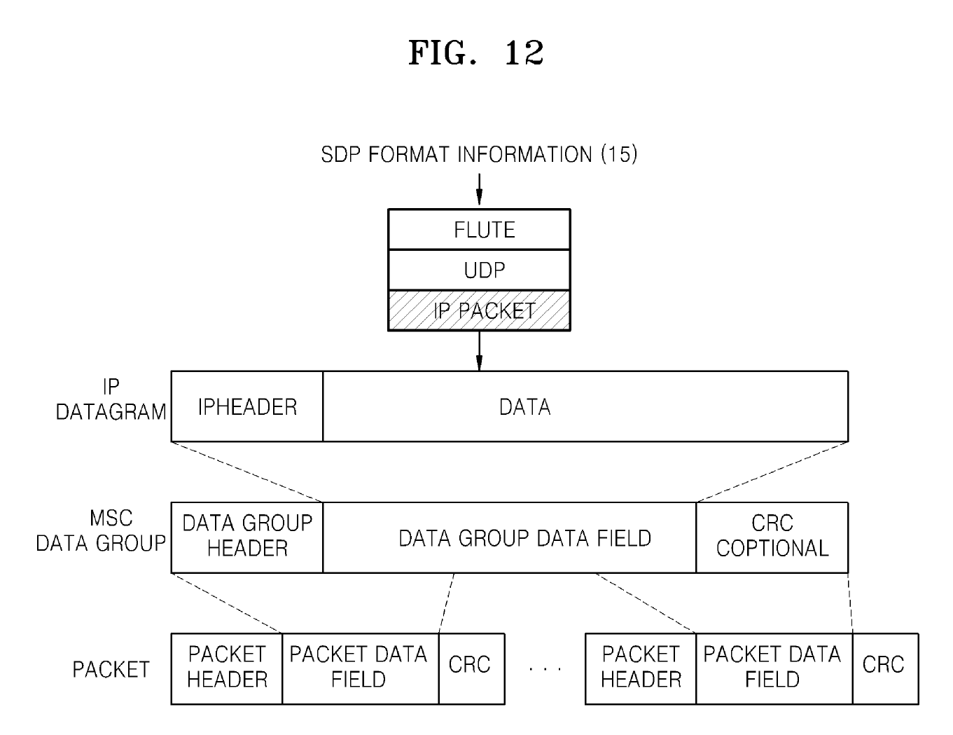

FIG. 12 is a view for explaining a transmission method using the IP packet illustrated in FIG. 8B, according to a second embodiment of the present invention.

Referring to FIG. 12, SDP format information 15 is IP-packetized, packetized into a MSC data group, then packetized into packet mode data, and transmitted to the DAB receiving apparatus 2.

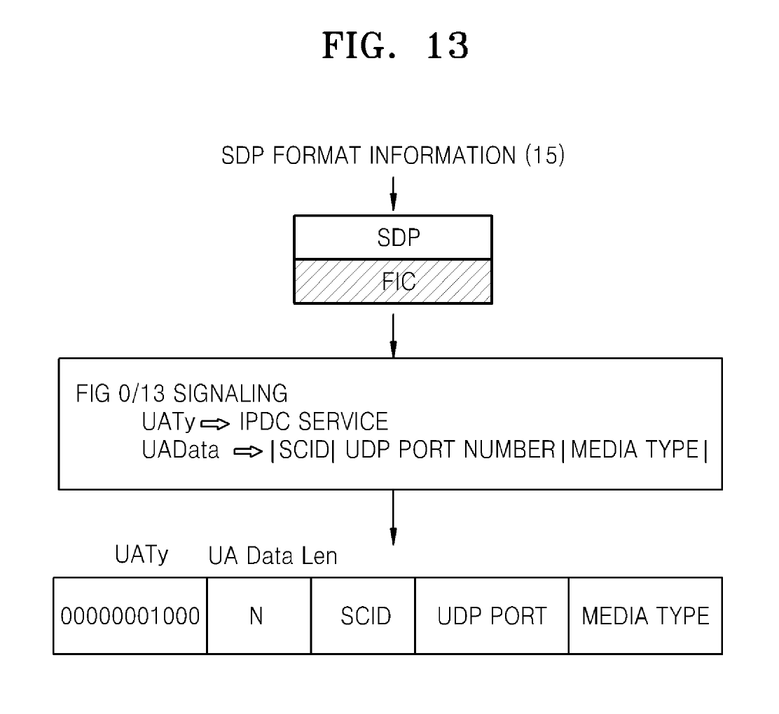

FIG. 13 is a view for explaining a transmission method using the FIC illustrated in FIG. 8C, according to a third embodiment of the present invention.

Referring to FIG. 13, SDP format information 15 is included in FIC 0/13 and then transmitted to the DAB receiving apparatus 2. At this time, the SDP format information 15 can be transmitted using combinations of fields of user application data. However, the invention is not limited to this.

As described above, configuration information of an IP datacasting service is included in an FIC by the control information channel processor 101 (see FIG. 5). Also, SDP format data and IP packet data which are IP packet configuration information are included in an MSC by the data service channel processor 103 (see FIG. 5), multiplexed into a DAB signal, and then transmitted to the DAB receiving apparatus 2 (see FIG. 3). Accordingly, the DAB transmitting apparatus 1 and the DAB receiving apparatus 2, according to the present invention, can appropriately process transmitted multimedia data according to the type of multimedia data since various information related to the multimedia data is transmitted together with the multimedia data, unlike an existing DAB transmitting apparatus and an existing DAB receiving apparatus used only as passages for IP tunneling without considering the content of data transmitted.

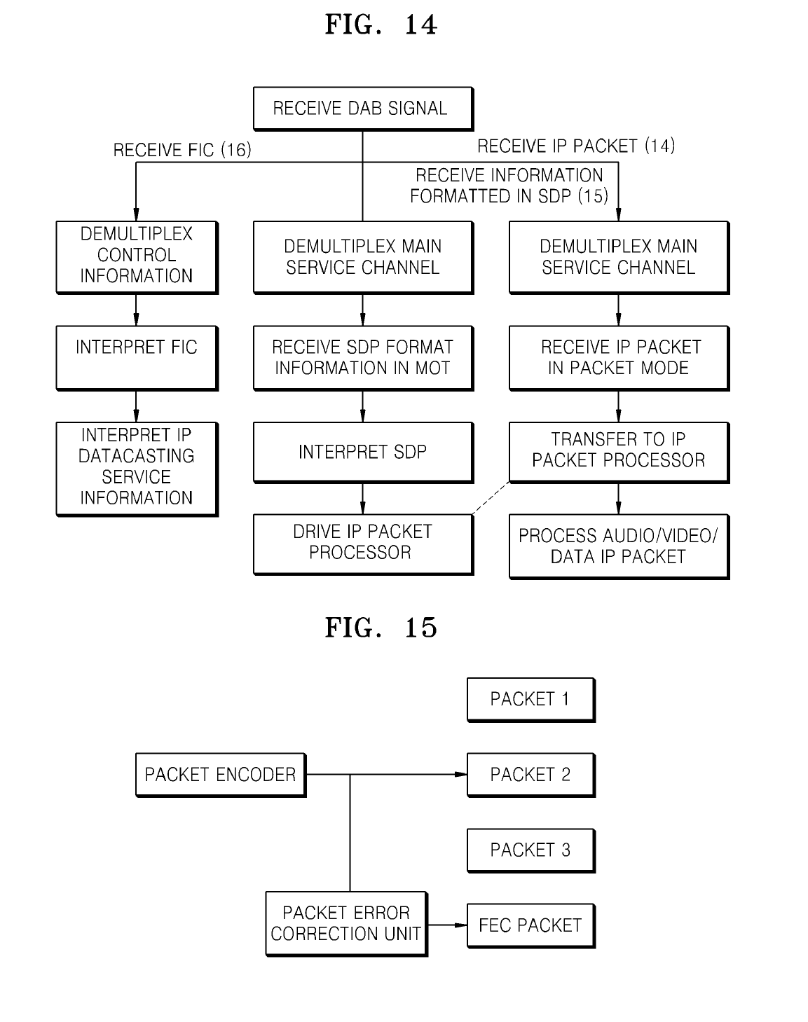

A DAB signal including an IP datacasting service is transmitted to the DAB receiving apparatus 2 and is processed by the DAB receiving apparatus 2. In detail, FIG. 14 is a view for explaining an operation of the DAB receiving apparatus 2 for providing an IP datacasting service, according to an embodiment of the present invention.

Referring to FIG. 14, if the DAB receiving apparatus 2 receives a DAB signal, the DAB receiving apparatus 2 demultiplexes and interprets control information of the corresponding FIC. At this time, the DAB receiving apparatus 2 interprets IP datacasting service information included in the FIC, thereby identifying that the following data is information regarding an IP datacasting service. For example, the DAB receiver 2 can identify by using a DSCTy field of the FIC that an IP packet is transmitted and identify by using an UAtype field of the FIC that an IP datacasting service is provided. Details regarding the FIC signaling have been described above with reference to FIGS. 9A and 9B.

Also, the DAB receiving apparatus 2 demultiplexes a main service channel (MSC), receives, as an MOT packet, SDP format information which is IP packet configuration information, and then interprets the SDP format information. The DAB receiving apparatus 2 drives an IP packet processor based on the interpreted IP packet configuration information.

Meanwhile, the DAB receiving apparatus 2 demultiplexes the main service channel (MSC), and transmits an IP packet to the IP packet processor if receiving the IP packet in a packet mode. The IP packet processor processes audio/video/data service information included in the IP packet data according to the type of each service. If the processed multimedia data is a file, the file is stored in a storage medium such as a memory. If the processed multimedia data is an audio stream, the audio stream is output through an audio outputting unit. If the processed multimedia data is a video stream, the video stream is output through an image display apparatus.

Meanwhile, the above-described embodiments of the present invention can be applied in various manners. For example, if an IP packet service based on the MPEG-2 TS is provided in a digital broadcasting system based on the MPEG-2 TS, such as DAB, DVB, ATSC, ISDB-T, etc., IP datacasting service configuration information is transmitted through a PSI/SI of the MPEG-2 TS-based packet, and IP packet configuration information such as SDP format information is transmitted through a program-related descriptor of the MPEG-2 TS-based packet, thereby configuring an effective IP datacasting service based on the MPEG-2 TS.

Hereinafter, various embodiments to which the IP datacasting service according to the present invention is applied will be described. FIGS. 15 through 19 are views for explaining various embodiments to which the IP datacasting service according to the present invention is applied.

First, FIG. 15 illustrates a case where a packet error correction unit is additionally installed in a packet encoder in order to transmit packets having a high error correction capability. Referring to FIG. 15, a packet forward error correction method rearranges packet data that have been packetized into packets each having a predetermined size in the direction of the columns, into the direction of the rows, using an interleaving method, and stores the interleaved packet data. The stored interleaved data is converted into RS packet data RS-coded by an error correction method such as the Reed Solomon method, and the RS packet data is packetized and transmitted. In this case, the fact that forward error correction (FEC) is applied as the corresponding packet transmission technique must be additionally notified by the IP datacasting service configuration information.

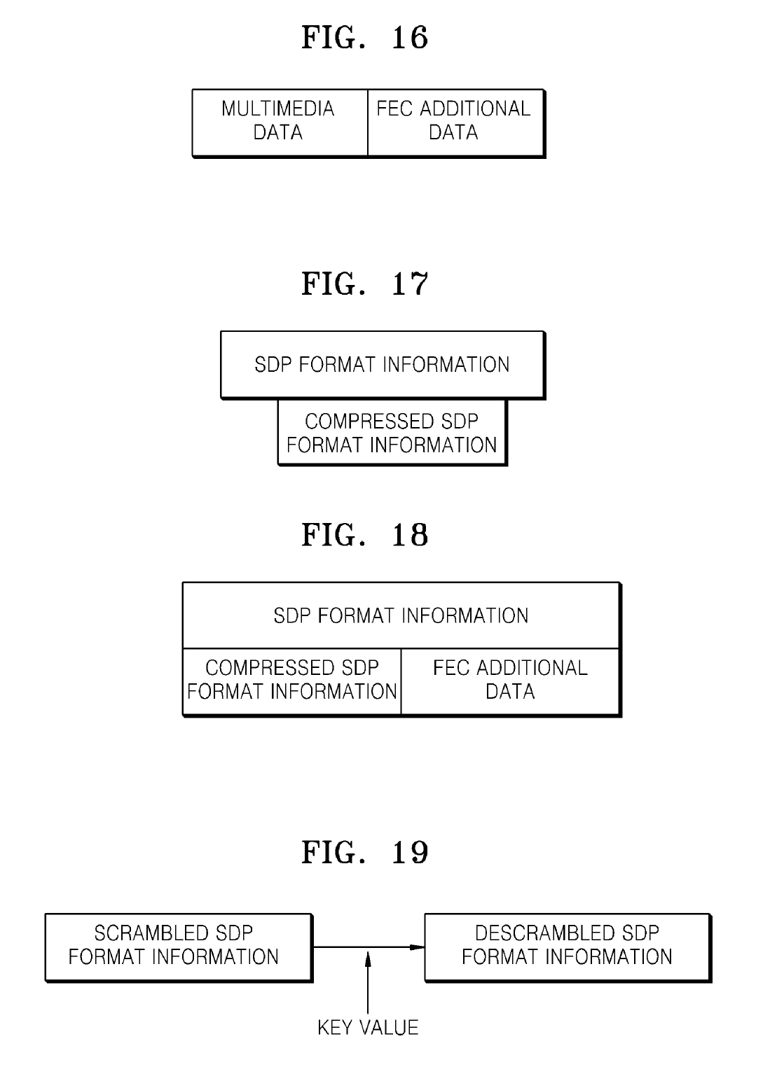

Meanwhile, FIG. 16 is a view for explaining an error correction method used when a multimedia file having a large capacity such as a moving-picture file is transmitted as an IP packet through an IP datacasting service. Referring to FIG. 16, in order to enhance error correction capability of a multimedia file having a large capacity, the packet error correction unit mentioned above is installed in the packet encoder (see FIG. 15), and additional error correction data (additional FEC data) is included and transmitted in the corresponding multimedia packet.

Also, FIG. 17 is a view for explaining an error correction method of SDP format information. Referring to FIG. 17, the SDP format information is transmitted as a MOT packet after being compressed by a lossless compression method such as GZIP to generate compressed data having a predetermined small size.

Also, FIG. 18 is a view for explaining another error correction method of SDP format information. Referring to FIG. 18, by including additional error correction data (additional FEC data) in the compressed SDP format information, transmission efficiency and an error-resistant effect can be enhanced.

Meanwhile, FIG. 19 is a view for explaining a method of providing an IP datacasting service as a pay service. Referring to FIG. 19, by scrambling SDP format information, a pay service can be provided so that only paid subscribers can receive a conditional access service (CAS). That is, by providing valid subscribers with a key value for unscrambling SDP format information, the valid subscribers can interpret the unscrambled SDP format information and process IP packets based on the interpreted information.

Other than the methods used in the embodiments described above, various cases where multimedia data is transmitted through an IP datacasting service can exist. IP datacasting service configuration information corresponding to methods used in these various cases must be transmitted through service information (SI) of the DAB system. Information, such as information indicating that additional FEC data is added to multimedia data, information indicating that SDP format information is compressed by a GZIP method, information indicating that FEC additional data is added to compressed SDP format information, information indicating that SDP format information is scrambled, etc., is preferably transmitted through the SI of the DAB system. Also, the information can be added to conventional electronic program guide information and transmitted, while being transmitted through the SI of the DAB system.

Meanwhile, the method for providing the IP datacasting service in the DAB system, according to the present invention, can be written as computer programs. Codes and code segments for constructing the programs can be easily construed by programmers skilled in the art to which the present invention pertains. Also, by storing the programs in a computer readable medium, and reading and executing the programs through a computer, the method for providing the IP datacasting service in the DAB system can be implemented. The information storage medium includes magnetic storage media, optical recoding media, and carrier wave media.

As described above, according to the present invention, there are provided a method and apparatus for providing an IP datacasting service in a DAB system. That is, in order to provide information regarding an IP packet when multimedia data is transmitted by using the IP packet, IP datacasting service configuration information is transmitted through a fast information channel (FIC), and IP packet configuration information and IP packet data are transmitted by using a data service of a main service channel (MSC).

Accordingly, a DAB transmitting apparatus and a DAB receiving apparatus, according to the present invention, can appropriately process transmitted multimedia data according to the type of the multimedia data since various information related to the multimedia data is transmitted together with the multimedia data, unlike an existing DAB transmitting apparatus and an existing DAB receiving apparatus used only as passages for IP tunneling without considering the content of data transmitted.

Also, by providing a transmission method for allowing a user to effectively and easily recognize IP packet configuration information in a DAB system, IP datacasting using the DAB system will be achieved in the future.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of providing an IP datacasting service in a digital broadcasting system, the method comprising:
generating service configuration information indicating that the IP datacasting service is provided;
packetizing data to be transmitted and generating IP packet data;
formatting information related to a configuration of the IP packet data by using a predetermined protocol; and
transmitting each of the service configuration information, the IP packet data, and the information related to the configuration of the IP packet data through a separate respective channel.

2. The method of claim 1, wherein the service configuration information is transmitted through a fast information channel (FIC).

3. The method of claim 1, wherein the IP packet data is transmitted using a data service of a main service channel (MSC).

4. The method of claim 1, wherein the information related to the configuration of the IP packet data is formatted in a session description protocol (SDP) format.

5. The method of claim 4, wherein the information related to the configuration of the IP packet data formatted in the SDP format is transmitted using a Multimedia Object Transfer (MOT) method among data services of a main service channel (MSC).

6. The method of claim 4, wherein the information related to the configuration of the IP packet data formatted in the SDP format is transmitted using an IP packet method among data services of a main service channel (MSC).

7. The method of claim 4, wherein the information related to the configuration of the IP packet data formatted in the SDP format is transmitted through a fast information channel (FIC).

8. A method of providing an IP datacasting service in a digital broadcasting system, the method comprising:
receiving a digital broadcast signal;
demultiplexing the received digital broadcast signal for each of a plurality of channels;
extracting service configuration information indicating that the IP datacasting service is provided, from a fast information channel (FIC);
extracting information related to a configuration of IP packet data formatted by using a predetermined protocol, from a main service channel (MSC);
extracting packetized transmission data from the MSC; and
processing the IP packet data using the extracted service configuration information and the extracted information related to the configuration of the IP packet data,
wherein the service configuration information, the information related to the configuration of the IP packet data, and the IP packet data are each received through a separate respective channel of the plurality of channels.

9. An transmitting apparatus for providing an IP datacasting service in a digital broadcasting system, the apparatus comprising:
an IP packetization unit which packetizes data to be transmitted and generates IP packet data;
a SDP formatting unit which formats information related to a configuration of the IP packet data by using a predetermined protocol; and
a controller which generates service configuration information indicating that the IP datacasting service is provided, and transmits each of the service configuration information, the IP packet data, and the information related to the configuration of the IP packet data, through a separate respective channel.

10. The transmitting apparatus of claim 9, wherein the service configuration information is transmitted through a fast information channel (FIC).

11. The transmitting apparatus of claim 9, wherein the IP packet data is transmitted using a data service of a main service channel (MSC).

12. The transmitting apparatus of claim 9, wherein the information related to the configuration of the IP packet data is formatted in a session description protocol (SDP) format.

13. The transmitting apparatus of claim 12, wherein the information related to the configuration of the IP packet data formatted in the SDP format is transmitted using a Multimedia Object Transfer (MOT) method among data services of a main service channel (MSC).

14. The transmitting apparatus of claim 12, wherein the information related to the configuration of the IP packet data formatted in the SDP format is transmitted using an IP packet method among data services of a main service channel (MSC).

15. The transmitting apparatus of claim 12, wherein the information related to the configuration of the IP packet data formatted in the SDP format is transmitted through a fast information channel (FIC).

16. A receiving apparatus for providing an IP datacasting service in a digital broadcasting system, the apparatus comprising:
a demultiplexer which demultiplexes a received digital broadcast signal for each of a plurality of channels;
a controller which extracts service configuration information indicating that the IP datacasting service is provided, from a fast information channel (FIC), and extracts information related to a configuration of IP packet data formatted with a predetermined protocol and packetized transmission data, from a main service channel (MSC); and
an IP packet processor which processes the IP packet data using the extracted service configuration information and the information related to the configuration of the IP packet data,
wherein the service configuration information, the information related to the configuration of the IP packet data, and the IP packet data are each received through a separate respective channel of the plurality of channels.
